(19) United States
(12) Patent Application Publication
(10) Pub. No.: US 2018/0144353 A1
(43) Pub. Date: May 24, 2018

(54) IDENTIFYING INSTALLATION SITES FOR ALTERNATIVE FUEL STATIONS

(71) Applicant: Propel Biofuels, Inc., Sacramento, CA (US)

(72) Inventors: Robert Elam, Portland, OR (US); Koichi John Kurisu, Portland, OR (US); Christopher P. La Plante, Seattle, WA (US); William Faulkner, San Francisco, CA (US); Parker Chase, Redwood City, CA (US)

(21) Appl. No.: 15/818,646

(22) Filed: Nov. 20, 2017

Related U.S. Application Data
(60) Provisional application No. 62/424,987, filed on Nov. 21, 2016.

(51) Int. Cl. G06Q 30/02

(52) U.S. Cl. CPC G06Q 30/0202; G06Q 30/0201

(57) ABSTRACT

Technology is disclosed to identify suitable installation sites for alternative fuel stations. The technology can use data sets pertaining to a particular geographic area, consumers of traditional or alternative fuel, fuel pricing history, brand information, area draw factors, and other data to generate various models. For example, the models can include any of an area capacity model that indicates the total number of stations that could be sustained by an area; a hotspot model that indicates estimated demand for alternative fuel within an area; or a trade area model that indicates locations within an area that are quickly accessible by a sufficiently high number of alternative fuel consumers. These models can be used in combination to identify and analyze potential sites suitable for alternative fuel stations.

### CROSS REFERENCE TO RELATED APPLICATIONS

This application claims the benefit of U.S. Provisional Application No. 62/424,987, filed Nov. 21, 2016, entitled “METHOD AND SYSTEM FOR IDENTIFYING INSTALLATION SITES OF ALTERNATIVE FUEL STATIONS,” which application is incorporated by reference herein in its entirety.

### BACKGROUND

Governments and citizens are increasingly concerned about environmental issues. Pollutants that contribute to global warming, such as carbon dioxide, are a particular concern. Vehicles powered by gasoline or traditional diesel produce a significant portion of the carbon dioxide generated each year. There has been an increase in interest in using alternative fuels to reduce these emissions. Some alternative fuels include biodiesel, which is produced from plant oils (most commonly soybean oil) and ethanol, which is generally produced from corn or sugar cane.

In order to make alternative fuels a viable option, it is necessary to provide consumers with a fueling station infrastructure that distributes those fuels. The installation of this infrastructure, including the installation of pumps and tanks at alternative fuel stations, requires significant resources. If the location of an alternative fuel station site is not near many consumers of alternative fuels, the site may generate insufficient business traffic to continue operation. Inconveniently located alternative fuel stations may also discourage consumers from making a switch from gasoline to alternative fuels. Therefore, it would be useful to have a way to identify alternative fuel station sites that are readily accessible by consumers of alternative fuels.

### BRIEF DESCRIPTION OF THE DRAWINGS

FIG. 1 is a block diagram illustrating components of an alternative fuel station siting system.

FIG. 2 is a flowchart of a process for identifying suitable station installation sites.

FIG. 3A is a flowchart of a process for developing a hotspot model for an area.

FIG. 3B is a flowchart of a process for determining a dataset type weights for developing a hotspot model for an area.

FIG. 4 illustrates an example graphical display of a hotspot model generated by the system.

FIG. 5 is a flowchart of a process for developing a trade area model for an area.

FIG. 6 illustrates an example graphical display of a trade area model generated by the system.

FIG. 7 is a flowchart of a process for analyzing hotspots and trade areas.

FIG. 8 illustrates a graphical display of a hotspot model in conjunction with a trade area model.

FIG. 9 is a block diagram illustrating a device on which the station siting system can operate.

FIG. 10 is a block diagram illustrating an environment in which the station siting system can operate.

The techniques introduced here may be better understood by referring to the following Detailed Description in conjunction with the accompanying drawings, in which like reference numerals indicate identical or functionally similar elements.

### DETAILED DESCRIPTION

A station siting system for evaluating installation sites of alternative fuel stations (“stations”) is disclosed herein. The system employs a novel methodology to facilitate the selection of high performing low carbon energy access points based on, e.g., proprietary variables. By appropriately siting stations, the system can have an immediate impact on a community by reducing greenhouse gas emissions (GHGs), improving air quality, and providing a more affordable choice for mainstream fuel consumers.

The system receives geocoded data sets and other data pertaining to a particular geographic area (the “area”). Using the received data, the system generates one or more models. The system can generate an area capacity model that indicates the total number of stations that could be sustained by the present and/or projected consumer demand for alternative fuel within the area. The system can generate a hotspot model that indicates the geographic variation of estimated demand for alternative fuel within the area. The hotspot model allows quick identification of “hotspots,” that is, locations where demand may be particularly high. The system can generate a trade area model that indicates which locations within the area are quickly accessible by a sufficiently high number of alternative fuel consumers. When combined, the various generated models facilitate identification and analysis of locations within the area that are the most suitable for a station site.

In generating and applying the models, the system can utilize datasets pertaining to alternative vehicle densities, traffic patterns, drive times, customer fueling patterns, household level behavioral characterizations, and trade area specific geographic attributes. The system can leverage detailed, household level segmentation to profile energy consumers based on demographics and psychographics. The unique transaction and behavioral data creates a complete customer profile combining alternative fuel usage patterns with drive-time statistics. The system can construct multivariate models leveraging this understanding of the energy consumer, along with other geographic retail factors. These models can be used in evaluation of future trade areas.

In addition to identifying potential commercially viable sites, the system can also identify locations with a high level of positive social, public health, and environmental impact. The system facilitates the exploration of locations relative to priority carbon value emphasis areas such as CalEPA data (CalEnviroScreen) measurements for environmental and health metrics at very granular geographic levels based on socioeconomic, health and environmental concerns.

Site surveys can be conducted as sites are identified in order to collect on-the-ground information, obtain specific station data from the owner, and perform feasibility evaluations. The information collected can be compiled, ranked, and mapped as part of the uniform methodology that determines where a station will be located.

In some implementations, model data can include regional permitting values. A regional permitting value can be a score (e.g. 1-5) indicating one or more of a difficulty level, cost, or expected time for obtaining permits for an alternative fuel station in the corresponding region. Regions can be defined by zip code, or by larger areas such as city, county, state, air districts, etc. In some implementations, regional permitting data can also specify particular critical permits for a region. In some implementations, the permitting data can be displayed when the system identifies an area for a potential station site. In some implementations, a general amount of time to obtain permits or times for particular critical permits can be included with the displayed permitting data. In some implementations, regional permitting surveillance is conducted to identify region specific permitting constraints.

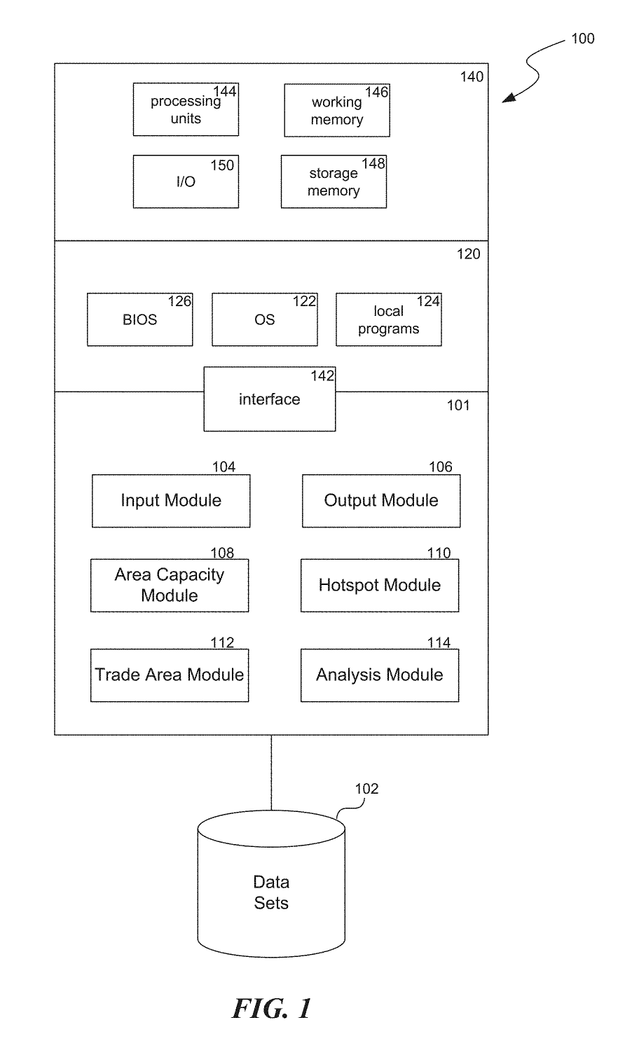

Turning now to the Figures, those skilled in the art will understand that aspects of the system may be practiced without many of these details and/or details may be implemented differently. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention. Those skilled in the art will further appreciate that the components illustrated in FIGS. 1-10 may be altered in a variety of ways. For example, the order of the logic may be rearranged, substeps may be performed in parallel, illustrated logic may be omitted, other logic may be included, etc. In some implementations, one or more of the components or data sources described above can be used by the components and processes described below.

FIG. 1 is a block diagram of a station siting system 100 for identifying suitable installation sites for alternative fuel stations. The components 100 include hardware 140, general software 120, and specialized components 101. As discussed above, a system implementing the disclosed technology can use various hardware including processing units 144 (e.g. CPUs, GPUs, APUs, etc.), working memory 146, storage memory 148, and input and output devices 150. In various implementations, storage memory 148 can be one or more of: local devices, interfaces to remote storage systems such as storage 1015 or 1025, or combinations thereof. For example, storage memory 148 can be a set of one or more hard drives (e.g. a redundant array of independent disks (RAID)) accessible through a system bus or can be a cloud storage provider or other network storage accessible via one or more communications networks (e.g. a network accessible storage (NAS) device, such as storage 1015 or storage provided through another server 1020). Components 100 can be implemented in a client computing device such as client computing devices 1005 or on a server computing device, such as server computing device 1010 or 1020.

General software 120 can include various applications including an operating system 122, local programs 124, and a basic input output system (BIOS) 126. Specialized components 101 can be subcomponents of a general software application 120, such as local programs 124. Specialized components 101 can include input module 104, output module 106, area capacity module 108, hotspot module 110, trade area module 112, analysis module 114, and components which can be used for providing user interfaces, transferring data, and controlling the specialized components, such as interface 142. In some implementations, components 100 can be in a computing system that is distributed across multiple computing devices or can be an interface to a server-based application executing one or more of specialized components 101. The system 100 can access one or more data sets 102. Using the data sets 102, the system 100 generates one or more models that permit a user to analyze whether various locations within an area are suitable for a station site.

The input module 104 is configured to access, e.g. via interface 142, data sets 102. Some of these datasets can be linked to, referenced by, mapped to, associated with, or otherwise indexed by data indicative of geographical location. Such data sets are hereinafter referred to as “geocoded data sets.” Examples of geocoded data can include consumer demographic information that is indexed by ZIP codes, regional road network data that is associated with latitude and longitude data, census and tax records, vehicle registration records, traffic density and flow data, business names, landmarks, waterways and topological features, and consumer demographic information. These examples are not intended to be exhaustive and other datasets, such as those discussed above, may be geocoded. Geocoded data may be indexed by or associated with many different types of geographical identifiers or indexing data, including but not limited to, street addresses, ZIP codes, parcel lot numbers, latitude and longitude, region (e.g. city, state, county) identifiers, etc. Furthermore, these geocoded data sets may be obtained from commercial and/or non-commercial sources.

Datasets 102 may include any additional data listed above such as vehicle information, traffic patterns, drive times, customer value variables, area draw variables, competition variables, interstate/highway proximity, customer profile data, social and environmental impact, competition information, and sales and branding data.

For example, the system can generate and apply models and perform station site selection based on a variety of variables such as: customer value variables, area draw variables, competition variables, or interstate/highway proximity. Customer value variables can include features of a potential station site which may be beneficial such as: residential proximity, traffic counts, site or area demographics, presence of occupied homes, presence or distance to residences with younger (e.g. below threshold age) occupants, or brand presence of existing pumps.

Residential proximity values take into account households within a particular distance or travel time (e.g. 20 minutes) of an area or potential station site. Traffic counts can be a count or average daily count of vehicles within a threshold distance of an area or potential station site. In some implementations, traffic data can be based on GPS tracking of select mobile devices and vehicles. Site or area demographics can include one or more of the following variables: expenditure (e.g. total or average) on gasoline or diesel fuels within a specified distance or travel time (e.g. 10 minutes); the count or percent of households with above a threshold number of vehicles (e.g. three) within a specified distance or travel time (e.g. 10 minutes); median age of the population within a distance or travel time (e.g. 15 minutes); unemployment rate within a distance or travel time (e.g. 20 minutes); or any combination thereof. A lower unemployment and/or a younger population can have a positive impact on expected performance.

Area draw variables can include features about areas within a threshold distance (e.g. half-mile) of an area or a potential station site which may be beneficial such as presence of co-tenant business groups such as auto supply stores, car rental businesses, fast food restaurants, pharmacies, etc.

Interstate/highway proximity can take into account the proximity of the nearest interstate/highway where a closer proximity has a stronger positive impact on performance.

Competition variables can indicate whether there is competition for providing alternative fuel at a potential station site such as: presence of other alternative fuel stations or presence of traditional gas stations (e.g. within a threshold distance). In some implementations, competition data can be obtained indicating competing stations that sell diesel, gasoline, or ethanol mixtures (e.g. E85) that are within a threshold distance or travel time (e.g. ten minutes) from an area or potential station site. In some implementations, competition data can be obtained from previous fuel sales, which can be divided by fuel type. For example, sales can be in divided into sales of ethanol mixtures (e.g. E85) and categories of diesel (e.g. B20, B10, B5, and HPR). In some implementations, fuel sale variables can be included on a cash basis, either in terms of amounts purchased with cash or revenues from cash sales. For example, a variable can be number of B20 diesel gallons sold for cash in a given time period. Another variable can be revenue from sales of High Performance Renewable (HPR) diesel. Another variable can be fuel prices for standard fuels (e.g. unleaded fuel) for a particular time period.

In some implementations, consumer value variables can be obtained from flexible-fuel vehicle (FFV) & diesel vehicle registration data. In some implementations, expenditure on gasoline can be obtained from customer transaction histories, such as credit card transaction data. In some implementations, purchase data can be correlated to particular customers, e.g. based on information the customers enter during transactions, such as a phone number or rewards number. Additional customer data can also be used such as physical address information or email addresses provided through loyalty programs, from newsletter registrations, customer service contacts, lead generation services, etc.

In some implementations, brand data can be obtained from existing station identifications, e.g. stores that participate in programs such as the clean fuel program by propel. In various implementations, information such as store/station/corporation/gas brands, products sold, price, or types of fuel sold can be obtained from the oil price information service (OPIS). In some implementations, some of the competition information can be obtained from OPIS.

In some implementations, modeling variables and site selection can be based on community pollution data. For example, site selection can be based on scores that account for communities most affected by many sources of pollution and where people are often especially vulnerable to pollution's effects, and thus would benefit from alternative fuel distribution stations. These scores can be based on environmental, health, and socioeconomic information. For example, data can be obtained from the California EPA Disadvantaged Communities CalEnviroScreen. The scores can be mapped so that different communities can be compared such that an area with a high score is one that experiences a much higher pollution burden than areas with low scores.

In some implementations, variables can be from association of a site with businesses having perceived positive impact on performance or association of a site with businesses having perceived negative impact on performance. In some implementations, modeling or site selection can account for stations that are on a station exclusion list.

The output module 106 is configured to provide data e.g. to a display, printer network destination, or other output. The output produced by the output module 106 can be in the form of moving or still images, raster, vector or point features, text, encoded data (e.g. html, xml, or database entries), sound, or the like. The output produced by the output module 106 can also comprise a combination or composite of one or more of these forms. For example, the output module 106 may be configured to produce an image of a street map overlaid with aerial images and a color-coded raster layer indicative of a geocoded data set of numerical values.

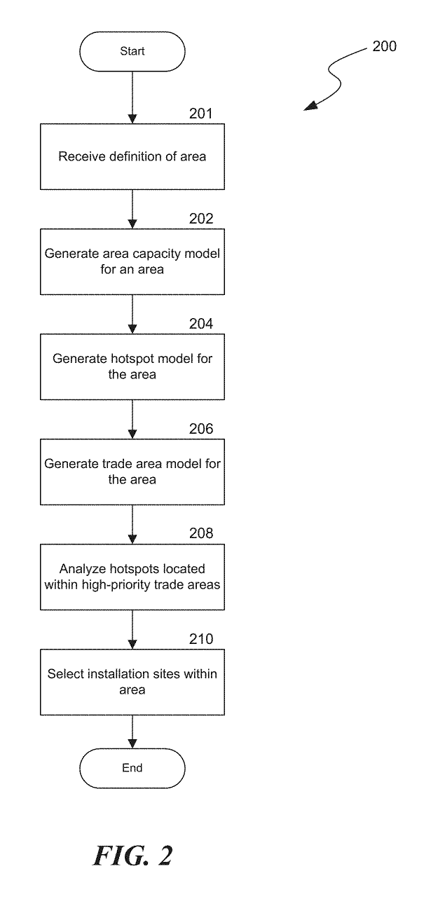

The system also has an area capacity module 108 for generating an area capacity model, a hotspot module 110 for generating a geocoded hotspot model, and a trade area module 112 for generating a geocoded trade area model. The three models and model-generating modules will be described in additional detail herein, in particular with respect to FIGS. 2 through 6.

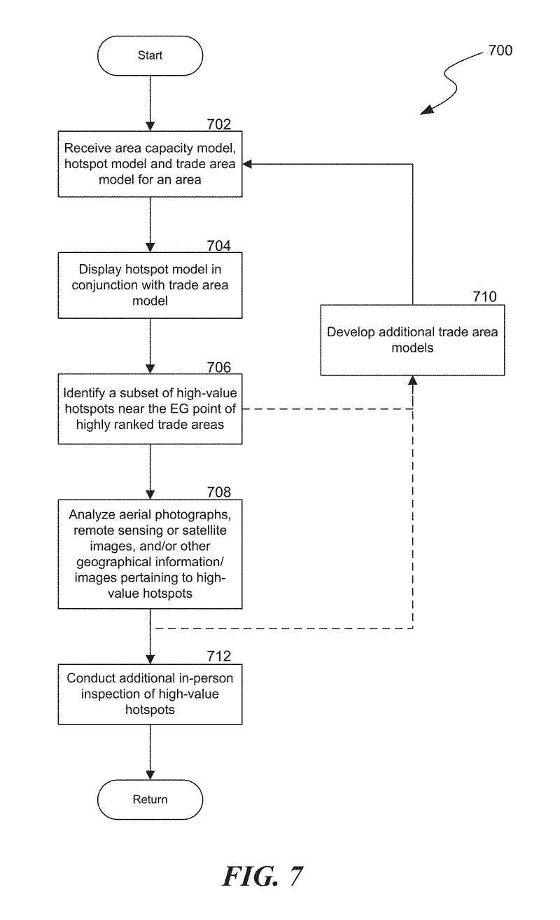

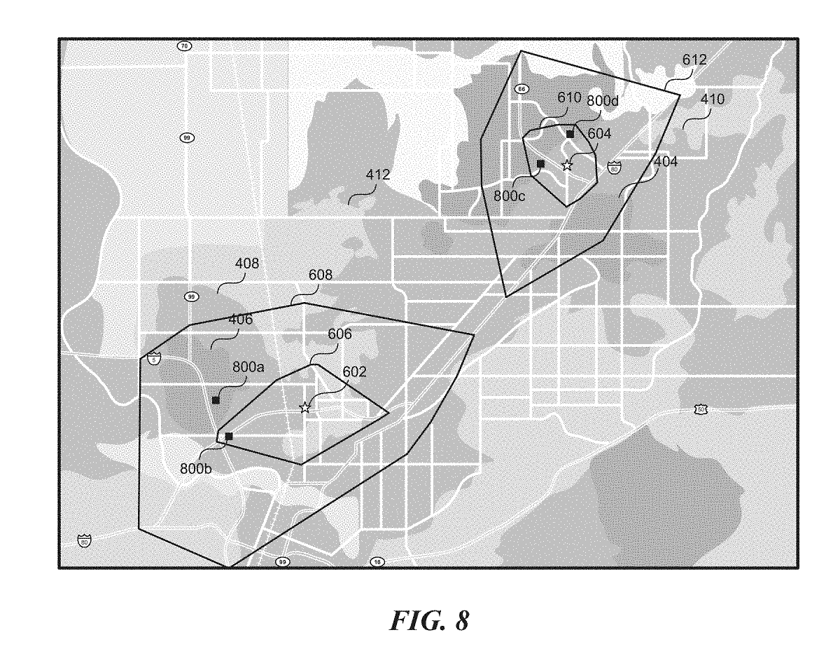

The system also has an analysis module 114 that provides functions for analyzing generated models or model results separately, in combination, and/or in conjunction with other geographical or geocoded data, information, images, or content. The functionality provided by the analysis module 114 will be discussed in greater detail herein with respect to FIGS. 7 and 8.

The various modules described, including the input module 104, output module 106, analysis module 114 and model-generation modules (area capacity module 108, hotspot module 110, and trade area module 112), may be partially or fully implemented to make use of one or more geographical information systems (“GIS”), including, but not limited to, commercial products such as Google Earth, which is distributed by Google Inc. of Mountain View, Calif., and ESRI ArcView, ArcGIS Spatial Analyst, ESRI ArcGIS Network Analyst, ESRI ArcView Network Analyst, and Arc2Earth, which are distributed by ESRI, Inc. of Redlands, Calif. The modules may also be implemented to use non-commercial and/or open source products such as Geographic Resources Analysis Support System (GRASS), which is sponsored by the Open Source Geospatial Foundation. Some modules may also be implemented to use other types of commercial or non-commercial software programs suitable for the manipulation and/or visualization of data, such as numerical analysis, or spreadsheet or database programs. For example, some modules may be implemented by Microsoft Excel, distributed by Microsoft Corp. of Redmond, Wash., Matlab, distributed by The MathWorks, Inc. of Natick, Mass., and/or the like. Alternatively, the various modules may be partially or fully implemented via customized computer software programs and/or hardware.

FIG. 2 is a flowchart of a process 200, implemented by the system, for identifying suitable station installation sites. At a block 201, the process 200 receives an area indication, e.g. designated from a system user. An area may be a neighborhood, town, city, county, a Consolidated Statistical Area as defined by the U.S. Office of Management and Budget, or any bounded geographic area. Once the area is defined, at a block 202 process 200 can generate, using by area capacity module 108, an area capacity model that indicates the total number of stations that could be sustained by the present and/or projected consumer demand for alternative fuel within the area. Processing then proceeds to block 204, where process 200 can generate using the hotspot module 110, a hotspot model that indicates the geographic variation of estimated demand for alternative fuel within the area. The hotspot model allows a user of the system to quickly identify “hotspots,” that is, locations where demand for alternative fuels may be particularly high. Processing then proceeds to block 206, wherein process 200 uses a drive-time analysis to generate, using trade area module 112, a trade area model that indicates which locations within the area are quickly (e.g. reachable below a threshold amount of time) accessible by a sufficiently high number (e.g. above a threshold amount) of alternative fuel consumers. In block 208, process 200 can facilitate, using the analysis module 114, analysis of hotspots located within high-priority trade areas. Processing then proceeds to block 210, where installation sites within the area are selected based on the results of the analysis. Each of these steps is described in further detail herein.

The area capacity model is used to estimate the total number of stations that could be sustained by the present and/or projected consumer demand for alternative fuel within an area. To generate the area capacity model for a given area, the area capacity module 108 receives or calculates the following actual, estimated, or projected information about the area:
the total number of alternative-fuel compatible vehicles (“compatible vehicles”) within the area (“N”) (compatible vehicles may include diesel fleet vehicles, diesel passenger cars and light-duty trucks, and/or flex-fuel compatible vehicles);
the percentage of area penetration among compatible vehicles (“P”);
the average volume of a fuel tank in an alternative-fuel compatible vehicle (“V”) (typically in gallons);
the average number of tank fillings made per compatible vehicle per year (“F”); and
the average volume of fuel that can be distributed annually by a single alternative fuel station (“S”) (typically in gallons).

One or more of these values may be received or calculated in the form of a numerical range. In one implementation, process 200 can calculate a value or range of N by aggregating vehicle registration and/or fleet vehicle data indexed by ZIP code to the area level, where an area is defined as a Consolidated Base Statistical Area as defined by the U.S. Office of Management and Budget.

Using these values, process 200 estimates an area's capacity for stations (“C”) by evaluating the following equation:

$$C = \frac{N * P * V * F}{S}$$

In some implementations, process 200 can utilize a sensitivity analysis of this equation to provide an estimated range of capacities. In these implementations, C may be expressed as a range. In some implementations, process 200 can contemporaneously calculate C for multiple areas to provide a comparison of the capacity of various areas; in this manner, the system can permit a user to prioritize various areas.

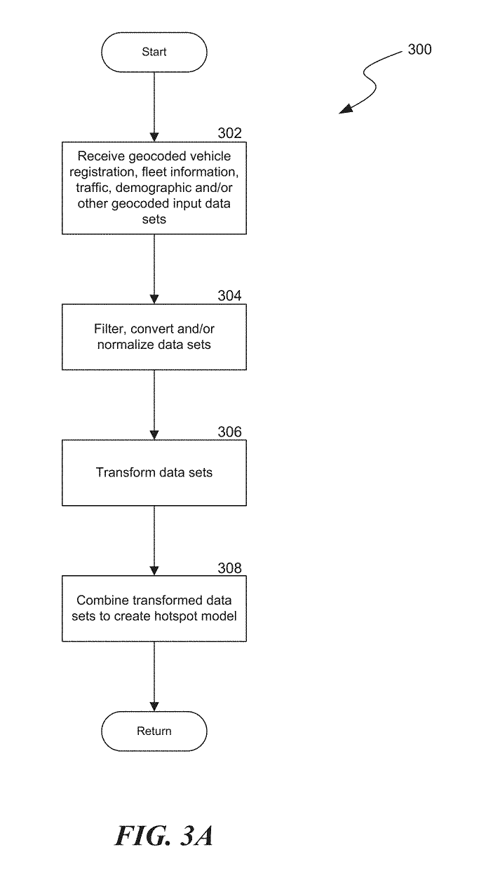

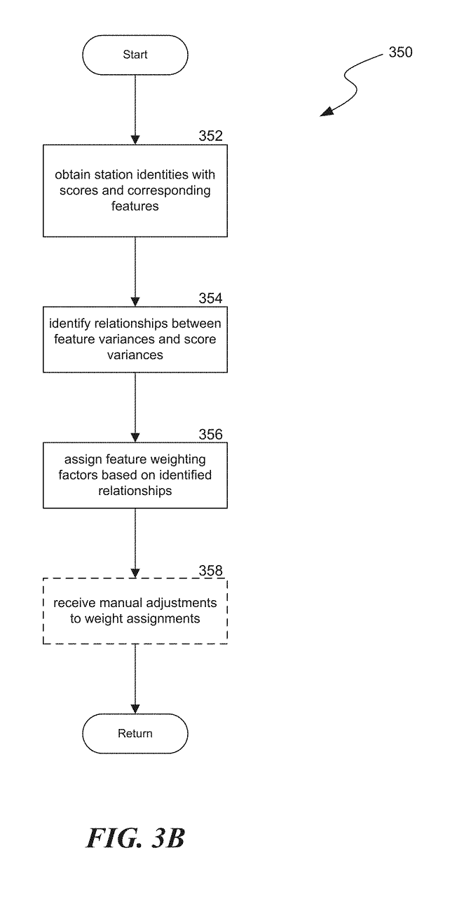

FIG. 3A is a flowchart of a process 300 for developing a hotspot model that is performed by the hotspot module 110. Processing begins in block 302, where process 300 receives or accesses input data sets that may be indicative of consumer demand for alternative fuels and/or other predictors of commercial success. Datasets can be explicitly geocoded, e.g. by being indexed by ZIP code, street address, street intersection, etc. Some data sets can be associated with an area without explicit geocoding, such as through indexing to other geocoded data. The following are non-exclusive examples of data sets that may be received or accessed which may be indicative of consumer demand and/or commercial success:
vehicle registration data (including make, model, fuel type, and/or vehicle class);
commercial fleet information;
traffic volume, flow, residential proximity, presence of occupied homes, residential density information, or highway proximity;
demographic or census information such as age, gender, marital status, annual income, and/or education level;
other consumer information, such as average motor fuel expenditures and/or disposable income;
sales information (e.g. for unleaded gasoline, by cash sales, or for alternative fuel types, such as by categories of diesel, ethanol, etc.);
area draw variables;
competition variables;
community pollution data; or
brand data or businesses' perceived impact.

After receiving the input data sets, processing proceeds to block 304, where at least some of the input datasets are converted and/or filtered to generate summary numerical data. For example, vehicle registration data indexed by ZIP code may be filtered to retain only those records corresponding to registered vehicles that are compatible with alternative fuel use. The filtered data may then be converted into a data set that numerically represents the density of compatible vehicles within each ZIP code or other geographic subdivision. Additionally, process 300 can normalize some of these data sets to unitless data before proceeding. Non-exclusive examples of appropriate normalizations include dividing each value in the data set by either (1) the mean of the data set, (2) the median of the data set, (3) the mean deviation of the data set, (4) a standard deviation of the data set, (5) an average absolute deviation, or (6) a value indicative of one or more moments of the data set. For those datasets that are not explicitly geocoded, process 300 may obtain area identifications through correlations with other data or may estimate distributions of the data across the identified area. For example, the process may assume a uniform distribution of the represented data across the identified area.

At block 306, process 300 can transform one or more of the input data sets (and/or filtered/converted/normalized data sets). The transformations may be linear (including an identity transformation) or non-linear. The transformations may also be invertible or non-invertible. Non-exhaustive examples of transformations to data sets include:
scaling the set (by a constant);
raising the set to a power;
taking a logarithm, derivative or integral of the set;
applying a ceiling or floor mapping to the set (i.e., quantization),
sorting the dataset into categories (e.g. by fuel type) and the like.

The transformations applied to a data set may also merge a number of these exemplary or additional transformations. For example, process 300 can transform a data set by first applying a ceiling mapping, and then scaling the result. Also, a different transformation may be performed on different data sets. For example, one data set may be scaled, while another data set may be quantized.

Processing then proceeds to block 308, where process 330 combines the various transformed data sets to create the hotspot model. The combination may be linear or non-linear. Non-exclusive examples of combinations include any polynomial of the various transformed data sets, including a simple summation of the various transformed data sets. Although the various transformed data sets may be indexed by different types of geographical identifiers having different scales (e.g., one set may be indexed by ZIP codes, another by street address), GIS techniques can be used to affect such a combination of disparate geocoded data, e.g. using ESRI ArcView and ESRI ArcGIS Spatial Analyst. Alternatively, process 300 can convert the geographical indexing of some data sets prior to the combination step to ensure that each data set is indexed by a common set of indexing data. Once the various data sets are converted to a common scale, the elements across the various data sets can be groups according to their corresponding geographical point or area. For example, data set values can be grouped for a particular address, within an area of a GPS point, by zip code, by city etc. The values for each group can then be combined, e.g. by determining their sum or average. In some implementations, before combining them, these data values can first be weighted, as discussed below.

In some implementations, process 300 generates the resultant hotspot model in any geocoded format that is readable by the analysis module 114 and the output module 106. For example, the hotspot model may be stored in KML form, point form, raster form, vector form, geodatabase form, or the like. Model generation may also be aided by additional GIS software tools that are configured to create readable geocoded file formats, such as Arc2Earth.

In some implementations, process 300 first normalizes each data set using the standard deviation of the data set (e.g., the standard deviation above and below the mean), and then scales each data set by a particular weighting constant, before finally summing the weighted data sets. Weighting factors can be mapped to particular data set types. One such mapping is provided in Table 1 below, which summarizes a weighted linear combination. For example, when combining two datasets, each data set can have a type and can include multiple data values, each data value corresponding to a piece of the area (i.e. can be geocoded). The weightings can be applied to each data set by applying, to each data value of that particular data set, a weighting mapped to the type of that particular data set. The weighted data values that correspond to the same point or location can be combined.

TABLE 1
Weighted linear combination utilized by one implementation of the hotspot
model generation process.

| | Weighting |
|---|---|
| Data Set | Constant |
| Per Capita Income | 5 |
| Average Fuel Purchases | 5 |
| Density of Traffic | 7 |
| Density of Diesel Vehicles: Passenger & Truck | 7 |
| Density of Diesel Vehicles: Fleets | 9 |
| Density of Flex Fuel Vehicles | 7 |

In some implementations, weighting factors can be determined, as shown in FIG. 3B, where weights are based on records of existing stations' performance, where factors that correlate to higher performance are more heavily weighted.

FIG. 3B is a flowchart of a process 350 performed by hotspot module 110 for determining dataset weighting factors to apply in developing the hotspot model for an area. The weighting factors are determined based on existing station performance. At block 352, process 300 obtains identifiers for multiple existing stations, where each identifier is associated with a performance score and a set of features for the particular site. In some implementations, computing a performance score can be based on various metrics such as overall sales amounts in a timeframe, sales amounts in timeframes in particular product categories, volumes of products sold, volumes of customers/traffic, etc. In some implementations, a user may be looking to identify potential station sites that are likely to excel in particular categories or types of sales. To accomplish this, the user can specify the metric to use when determining scores for existing stations which, through the process in blocks 354-358, will determine weighting factors likely to identify sites or areas that will promote these goals. For example, if a user is looking for a site that will perform well in E85 sales, the user can have E85 sales of existing stations be heavily weighted when scoring exiting station performance.

At block 354, process 350 identifies relationships between station performance scores and changes in various scoring factors. In some implementations, determining these relationships is be accomplished through regression analysis to determine the extent to which particular scoring factors affect performance scores. In some implementations, other analyses are performed to correlate an amount that particular features affect a performance scores. For example, station identifiers can be sorted according to whether they are high performers (e.g. above average score) or low scorers (e.g. below average score) and the factors can be analyzed to determine which change the most between the high scoring performers and the low scoring performers.

At block 356, process 350 can assign a set of weighting factors, such as those shown in Table 1, based on the relationships identified in block 354. In some implementations, the weighting factors represent the strength of the relationship determined between the scoring factor and resulting scores, i.e. how much that scoring factor is expected to affect performance scores.

Optionally (as indicated by the dashed lines), at block 358, manual adjustments or alternative adjustments can be applied to the weighting factors. For example, a system user may have special knowledge about a particular site or region under consideration and adjust weighting factors or pick a particular transformation for one or more weighting factors to account for those considerations. As a more specific example, a user may know that customers in an area, e.g. the San Francisco Bay Area, are less likely to make a drive over 10 minutes to reach a fuel stations as compared to customers generally or customers in more rural areas. To account for this preference, the user can specify a higher weight for a “distance to residences” factor. In some implementations, a set of weighting factor modifications can be pre-established for various region types. For example, an “urban” weight adjustment set can be selected which augments weights to accentuate drive time and existing brand factor types; a “rural” weight adjustment set can also be selected which augments weights for traffic counts and competition factor types.

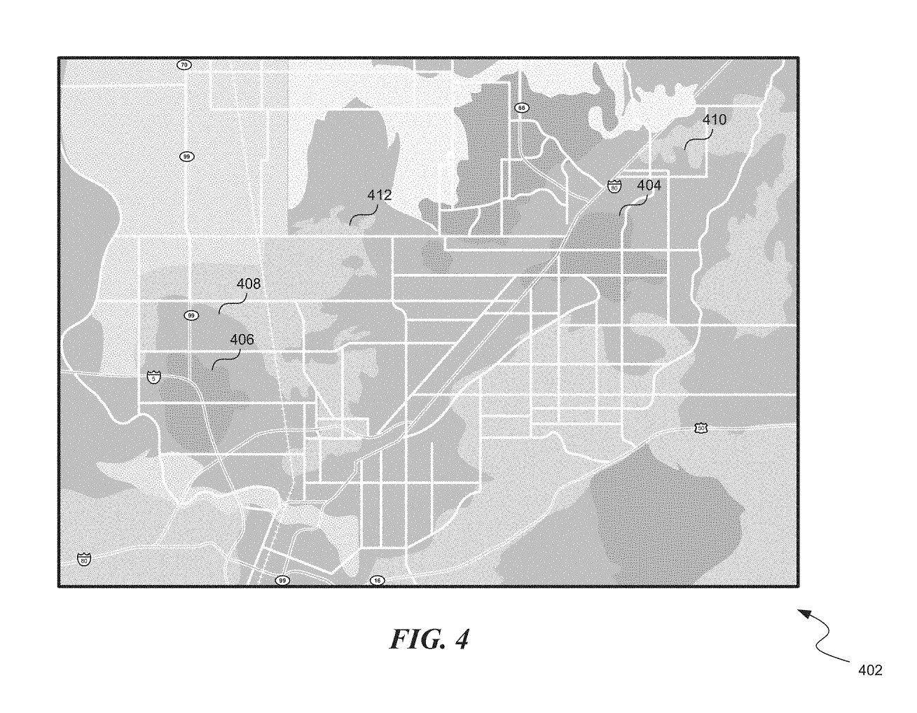

FIG. 4 illustrates a hotspot model generated by a weighted linear combination that is displayed in conjunction with a street map 402 using the output module 106 and the analysis module 114. “Hotspots” are locations or regions that the hotspot model determines have a higher value relative to other areas or that surpass a threshold value. In some implementations, the geographic variation of the hotspot model is indicated graphically by a color gradient or grayscale gradient. For example, the map 402 in FIG. 4 uses a first grayscale level in areas 404 and 406 to indicate high relative value. Similarly, the second grayscale level in areas 408 and 410 indicates medium value. The third grayscale level in area 412 indicates a low relative value. As depicted in FIG. 4, when displayed graphically, the hotspot model readily conveys information regarding which areas within an area may have greater consumer demand for alternative fuels. Other implementations may utilize other types of graphical indicators besides color or grayscale gradients to visually indicate the geographical variation of the hotspot model.

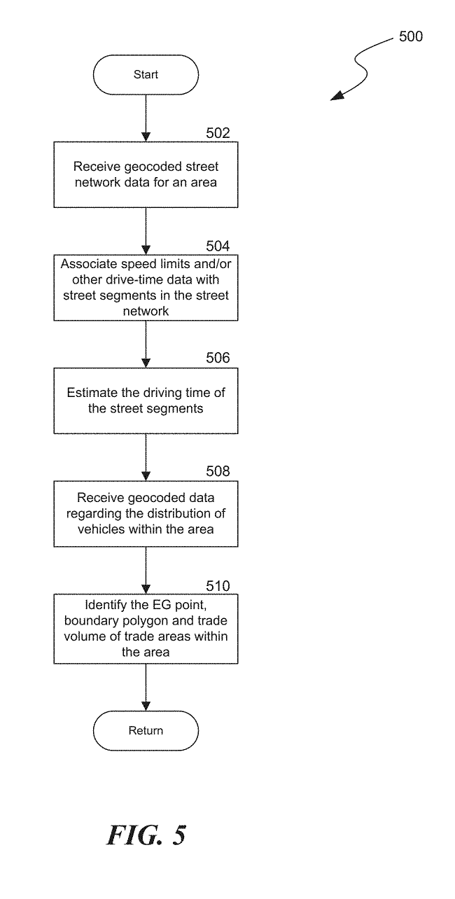

FIG. 5 is a flowchart of a process 500 for developing a trade area model for an area performed by the trade area module 112. Processing begins at block 502, where process 500 receives one or more geocoded data sets representing an area. The geocoded data sets may, for example, comprise data pertaining to street segments. Processing next proceeds to block 504, where process 500 can associate the street network data with speed limits and/or other data that indicate the driving times of vehicles within the street network (e.g., typical observed traffic patterns, elevation changes, road types, traffic lights, etc). Process 500 then proceeds to block 506, where it uses the received data to estimate the typical time needed to drive the length of each street segment within the street network, e.g. using an ESRI ArcGIS Network Analyst.

After estimating the drive time of street segments, processing proceeds to block 508, where process 500 receives geocoded data indicative of the distribution or density of compatible vehicles within the area. For example, process 500 may receive vehicle registration data (e.g., data pertaining to vehicle make, model, or class) that are indexed by street address or ZIP code and/or corporate diesel fleet data that are indexed by street address or ZIP code. Although not shown in FIG. 5, after process 500 has received the data, process 500 may filter and/or convert the received geocoded data into summary numerical data. For example, vehicle registration and fleet data indexed by ZIP code may be filtered to retain only those records corresponding to compatible vehicles, and may then be converted into a data set that numerically represents the density of compatible vehicles within each ZIP code or other geographic subdivision.

Processing then proceeds to block 510, where process 500 uses the received geocoded data to identify trade areas that exist within an area. A trade area can be substantially a polygon-shaped geographic area on a map of the area that satisfies certain criteria. One criteria can be that the polygon must have an equidistant geographical point (“EG point”) which may be reached from any point in the polygon within T minutes of estimated driving time. In some implementations, T can be specified by a user (typically in minutes). Another criteria can be that the polygon must circumscribe a geographic area having an estimated M number of compatible vehicles. In some implementations, M can be a user-specified parameter. The estimated number of compatible vehicles circumscribed by a trade area polygon is hereinafter referred to as the “trade volume” of a trade area. While a polygon can be used for computational purposes, it will be appreciated that other geometric shapes such as circles, ovals, rectangles, etc. may be used to identify trade areas.

In some implementations, EG points may be limited to the center points (or centroid) of each ZIP code in the area and/or to certain other points or areas within the area. In some implementations, trade area models may be developed for more than one value of T; for example, two models may be simultaneously developed, one for T=6 minutes and one for T=12 minutes. In some implementations, trade areas may be chosen for M=500 or M=3000.

In some implementations, trade areas are identified automatically; e.g. using GIS tools. Non-exclusive examples of GIS tools include ESRI ArcGIS Network Analyst and ESRI ArcView Network Analyst. The set of all determined trade areas, including EG points, polygons, and trade volumes, is referred to as a “trade area model.” The trade area model may be generated in any geocoded format that is readable by the analysis module 114 and the output module 106. For example, the trade area model may be stored in KML form, point form, raster form, vector form, geodatabase form, or the like, or in a combination of these forms.

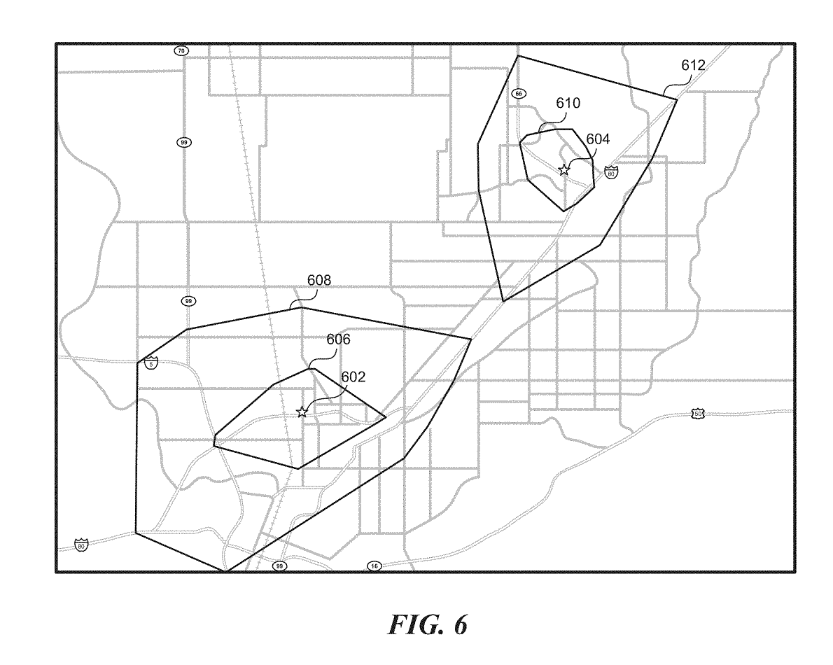

FIG. 6 illustrates two trade area models displayed by the system in conjunction with a street map. The stars 602 and 604 indicate EG points of various trade areas. The polygons 606, 608, 610, and 612 in the figure indicate the boundaries of the trade areas. The trade area model having smaller polygons 606 and 610 corresponds to T=6 minutes, the trade area model having bigger polygons 608 and 612 corresponds to T=12 minutes. As seen in FIG. 6, when displayed graphically, the trade area model readily conveys information regarding which locations within the area are quickly accessible for a large number of alternative fuel consumers.

FIG. 7 is a flowchart of a process 700 for analyzing hotspots located within trade areas. Some or all of the steps shown in FIG. 7 may be facilitated or implemented by the analysis module 114. Processing begins in block 702, where process 700 receives an area capacity model, a hotspot model, and a trade area model. Process 700 may also receive other data, models, and/or images pertaining to the area, including but not limited to street maps, aerial photographs, or satellite or remote sensing images.

After receiving the models and/or data, processing proceeds to block 704, where the system displays a representation of the hotspot model in conjunction with the trade area model in graphical form. Additionally, the system may display street maps, satellite photographs, aerial or remote sensing images and/or other types of geographical data or images in conjunction with these two models. FIG. 8 depicts the display of a hotspot model in conjunction with a trade area model, both overlaid on a street map.

Although not shown in FIG. 8, process 700 may also rank the various trade areas. To do so, process 700 may assign a higher-priority ranking e.g. based on trade areas having a higher trade volume, residential proximity values, traffic counts, site or area demographics, area draw variables, or other variables. The system may therefore also provide an indication of the relative rankings. For example, the system may display a numerical rank next to each trade area.

After displaying the information, processing proceeds to block 706, where process 700 identifies locations where a hotspot appears near an EG point of highly ranked trade areas. In some implementations, a specified threshold can be used for determining trade areas as highly ranked or whether an area qualifies as a hotspot. In some implementations, values for these thresholds can depend on characteristics of an area. For example, threshold adjustments can be provided based on residential population density, industry type, alternative fuel vehicle density, existing sales information, average population age, etc. Hereinafter, locations that are within a threshold distance of where a hotspot appears within a threshold distance to an EG point of highly ranked trade areas is referred to as an “identified site.” Such identified sites may be highly suitable for a station site as they combine high consumer demand and/or other indicators of commercial success (as indicated by the relatively high value shown on the hotspot model) with quick access to a large group of alternative fuel consumers (as indicated by the trade area model). Process 700 can present these identified sites to the user by adding additional graphical indicators to the display, such as point, vector, or raster features. In some implementations, process 700 can first present identified sites associated with higher-ranked trade areas before presenting identified sites in lower-ranked trade areas. In still other implementations, process 700 can present the user with the identified sites associated with trade areas having the C highest trade volumes, where C is the area's capacity for stations, as determined by the area capacity model.

Alternatively, in some implementations, process 700 can receive indications of manually identified locations where the hotspot model has a particularly high value near a highly ranked EG point (also “identified sites”). For example, process 700 can provide an interface that permits zooming in on a particular geographical location near a highly ranked EG point to inspect the values of the hotspot model near that geographical location. In some implementations, the interface can also permit the user to add additional graphical indicators to the display at the location of the manually identified sites, to “bookmark” identified sites, and/or to rank identified sites.

In some implementations, the interface can also include key decision indicators which show how various factors contributed to the suggestion of an area for a station site. Key decision indicators can be shown in association with a suggested station site or area. In various implementations, a set amount (e.g. 3) key decision factors can be shown or the key decision factors that contributed to the site or area selection above a threshold amount can be shown. For example, any factor that contributed to at least 20% of a score for a suggested site or area can be provided as a key decision factor. In some implementations, key decision factors can also show factors that strongly detracted from a site or area score (e.g. that lowered the score at least a threshold amount).

As shown in FIG. 7 processing then proceeds to block 708, where process 700 can provide an interface for analyzing aerial photographs and/or remote sensed or satellite images at or near identified sites to determine what physical features are present at the identified sites and/or locations near the identified sites. In this way, a user may determine whether each identified site has physical features suitable for an alternative fuel station. For example, by analyzing aerial photographs of identified sites, the user may determine whether there is an existing traditional gas station or sufficient undeveloped or underdeveloped space nearby that could make the installation of an alternative fuel station easier. In some implementations, such physical features are automatically identified in the interface, based on, e.g. OPIS data, mapping systems, EPA data, etc. Using this analysis, the user may develop a refined set of potential sites that have desirable physical characteristics, in addition to having a high hotspot model value and proximity to a highly ranked EG point. Such sites are referred to herein as “visually analyzed sites.” The interface provided by process 700 can also permit the user to add additional graphical indicators to the display at the location of the visually analyzed sites, e.g. to “bookmark” the location of these sites, and/or to rank or prioritize these visually analyzed sites. This portion of the analysis may be effectuated by GIS software such as Google Earth.

In some implementations, process 700, at block 710, generates one or more additional trade area models based on the results of previous steps in process 700. In some implementations, at this step, generating these additional trade area models is limited to selecting EG points that are identified sites, visually analyzed sites and/or locations within a threshold distance of these sites. In this way, the system permits the trade area model to be refined. In some implementations, after new trade area models are generated, the steps of the analysis process shown in FIG. 7 can be repeated using the newly-generated trade area models.

As shown in FIG. 7, using the results provided by the analysis process, in block 712, additional factors for potential sites are determined. In some implementations, these additional factors can be determined through an in-person inspection of one or more of the potential sites. During an inspection or through information gathered from other sources such as mapped roadway, retailer, OPIS, traffic logging, or geo-mapping data, additional factors that would indicate commercial success can be provided for further refinement of site selection. For example, such additional information can include one or more of the following characteristics:
proximity to shopping centers, grocery stores, large retailers (“big box retailers”) and/or highway exits;
traffic access, density, or flow, residential proximity, presence of occupied homes, population density information, or highway proximity;
accessibility and visibility from the street;
site attractiveness or appearance;
amount of space available to accommodate alternative fuel tanks and/or pumps;
demographic or census information for people within a threshold distance from the site such as age, gender, marital status, annual income, and/or education level;
other consumer information for people within a threshold distance from the site as average motor fuel expenditures and/or disposable income;
regional permitting values;
expected station construction costs;
costs for delivering alternative fuels to a site;
competition variables;
community pollution data; or
brand data or businesses' perceived impact.

Weighing these factors along with the information provided by process 700, the system or the user may select installation sites. In some implementations, in order to select installation sites, the factors and analysis information may be entered into a Site Attribute Survey and graded on overall suitability for developing a station. In still other implementations, to select installation sites, an economic model (e.g., pro forma) may be developed.

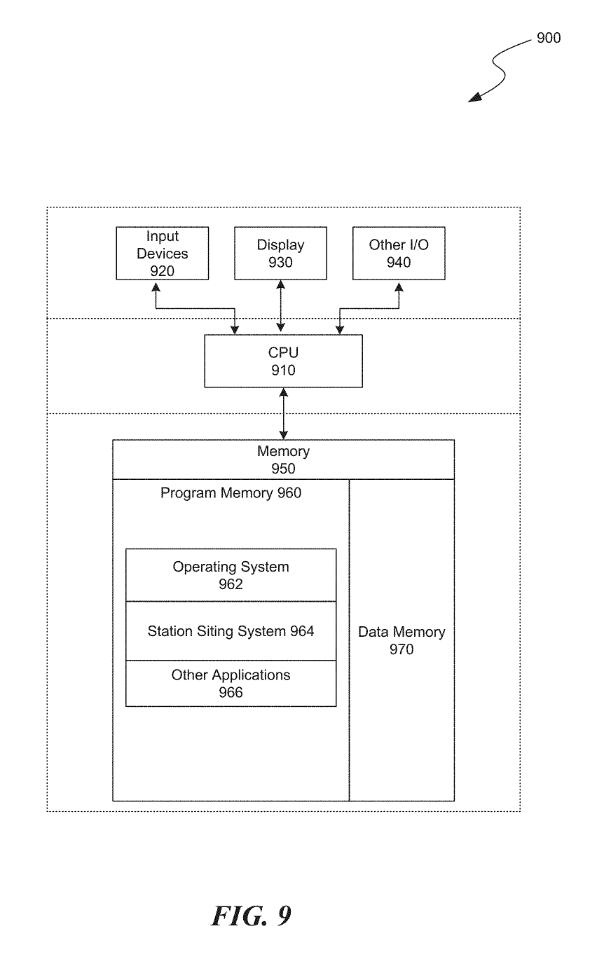

FIG. 9 is a block diagram illustrating a device 900 on which the station siting system can operate. The devices can comprise hardware components of a device 900 that can perform model generation or model application for site selection. Device 900 can include one or more input devices 920 that provide input to the CPU(s) (processor) 910, notifying it of actions. The actions can be mediated by a hardware controller that interprets the signals received from the input device and communicates the information to the CPU 910 using a communication protocol. Input devices 920 include, for example, a mouse, a keyboard, a touchscreen, an infrared sensor, a touchpad, a wearable input device, a camera- or image-based input device, a microphone, or other user input devices.

CPU 910 can be a single processing unit or multiple processing units in a device or distributed across multiple devices. CPU 910 can be coupled to other hardware devices, for example, with the use of a bus, such as a PCI bus or SCSI bus. The CPU 910 can communicate with a hardware controller for devices, such as for a display 930. Display 930 can be used to display text and graphics. In some implementations, display 930 provides graphical and textual visual feedback to a user. In some implementations, display 930 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 940 can also be coupled to the processor, such as a network card, video card, audio card, USB, firewire or other external device, camera, printer, speakers, CD-ROM drive, DVD drive, disk drive, or Blu-Ray device.

In some implementations, the device 900 also includes a communication device capable of communicating wirelessly or wire-based with a network node. The communication device can communicate with another device or a server through a network using, for example, TCP/IP protocols. Device 900 can utilize the communication device to distribute operations across multiple network devices.

The CPU 910 can have access to a memory 950 in a device or distributed across multiple devices. A memory includes one or more of various hardware devices for volatile and non-volatile storage, and can include both read-only and writable memory. For example, a memory can comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 950 can include program memory 960 that stores programs and software, such as an operating system 962, station siting system 964, and other application programs 966. Memory 950 can also include data memory 970, e.g. model datasets, weighting factors, mapping data, configuration data, settings, user options or preferences, etc., which can be provided to the program memory 960 or any element of the device 900.

Some implementations can be operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

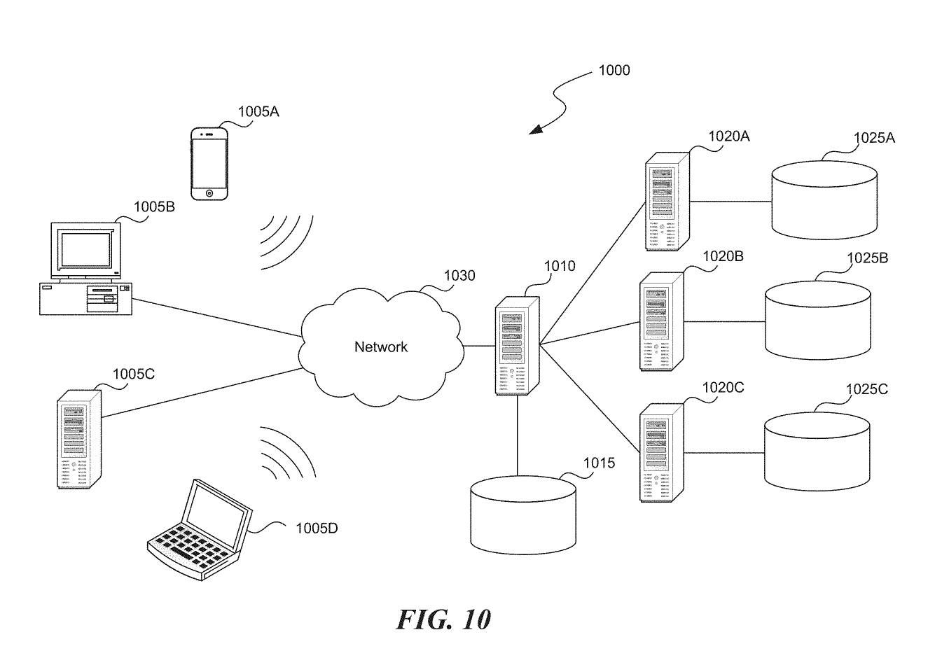

FIG. 10 is a block diagram illustrating an environment 1000 in which the station siting system can operate. Environment 1000 can include one or more client computing devices 1005A-D, examples of which can include device 900. Client computing devices 1005 can operate in a networked environment using logical connections 1010 through network 1030 to one or more remote computers, such as a server computing device.

In some implementations, server 1010 can be an edge server which receives client requests and coordinates fulfillment of those requests through other servers, such as servers 1020A-C. Server computing devices 1010 and 1020 can comprise computing systems, such as device 900. Though each server computing device 1010 and 1020 is displayed logically as a single server, server computing devices can each be a distributed computing environment encompassing multiple computing devices located at the same or at geographically disparate physical locations. In some implementations, each server 1010 or 1020 corresponds to a group of servers.

Client computing devices 1005 and server computing devices 1010 and 1020 can each act as a server or client to other server/client devices. Server 1010 can connect to a database 1015. Servers 1020A-C can each connect to a corresponding database 1025A-C. As discussed above, each server 1020 can correspond to a group of servers, and each of these servers can share a database or can have their own database. Databases 1015 and 1025 can warehouse (e.g. store) information. Though databases 1015 and 1025 are displayed logically as single units, databases 1015 and 1025 can each be a distributed computing environment encompassing multiple computing devices, can be located within their corresponding server, or can be located at the same or at geographically disparate physical locations.

Network 1030 can be a local area network (LAN) or a wide area network (WAN), but can also be other wired or wireless networks. Network 1030 may be the Internet or some other public or private network. Client computing devices 1005 can be connected to network 1030 through a network interface, such as by wired or wireless communication. While the connections between server 1010 and servers 1020 are shown as separate connections, these connections can be any kind of local, wide area, wired, or wireless network, including network 1030 or a separate public or private network.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g. “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

Although the subject matter has been described in language specific to structural features and/or methodological acts, it is to be understood that the subject matter defined in the appended claims is not necessarily limited to the specific features or acts described above. Specific implementations and implementations have been described herein for purposes of illustration, but various modifications can be made without deviating from the scope of the implementations and implementations. The specific features and acts described above are disclosed as example forms of implementing the claims that follow. Accordingly, the implementations and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A computer-implemented method for identifying alternative fuel station sites, the method comprising:
generating an area capacity model for an area, wherein the area capacity model indicates estimated capacities, for alternative fuel stations, in each of multiple portions of the area;
generating a hotspot model indicating one or more hotspots within the area, wherein each hotspot corresponds to a geographical area within the area that is predicted to have demand for alternative fuels above a threshold level and wherein the hotspot model is determined based on:
a number of vehicles, associated with potential hotspots in the area, that are capable of using alternative fuels;
presence of other alternative fuel stations within a threshold distance of potential hotspots; and
categorized historical sales information, associated with potential hotspots in the area, for categories of alternative fuels;
generating a trade area model indicating one or more trade areas within the area, wherein the trade area model is determined based on predicted drive times, by consumers of alternative fuels, to reach a particular point within the trade area; and
generating, based on the area capacity model, the hotspot model, and the trade area model, indications of multiple proposed installation sites for alternative fuel stations.

2. The computer-implemented method of claim 1, wherein generation of the area capacity model is based on at least one of:
a total number of alternative fuel-compatible vehicles in the area,
an area of alternative fuel-compatible vehicles in the area,
an average volume of tank filling purchases for alternative fuel compatible vehicles,
an average number of tank fillings made per compatible vehicle in a period of time,
an average volume of fuel that can be distributed by an alternative fuel station, or
any combination thereof.

3. The computer-implemented method of claim 1 further comprising indicating an order among the multiple proposed installation sites, wherein the order is based on one or more of:
an amount of trade volume in a corresponding trade area;
residential proximity values;
site or area demographics;
area draw variables; or
any combination thereof.

4. The computer-implemented method of claim 1, wherein generating the hotspot model is further based on at least one of:
presence of traditional gas stations within a threshold distance of potential hotspots;
brand data for existing fuel stations at potential hotspots;
measures of social, public health, or environmental impact for potential hotspots;
vehicle registration data;
traffic volume, flow, or density;
consumer demographic information;
previous consumer income or fuel expenditures, or
any combination thereof.

5. The computer-implemented method of claim 4, wherein at least some of the data used to generate the hotspot model is indexed by ZIP code, street address, or cross-street.

6. The computer-implemented method of claim 1,
wherein generating the hotspot model includes performing a statistical transformation on a geocoded input data set, and
wherein the statistical transformation is one or more of scaling the input data set, raising the input data set to a power, taking a logarithm of the input data set, taking a derivative of the input data set, taking an integral of the input data set, quantizing the input data set, or any combination thereof.

7. The computer-implemented method of claim 1, wherein the indications of multiple proposed installation sites are provided as part of a graphically displayed map with markings depicting geographical locations for the proposed installation sites.

8. The computer-implemented method of claim 1, wherein at least one of the multiple proposed installation sites is based on a determination of a selected area in which the one or more hotspots overlap with the one or more trade areas.

9. The computer-implemented method of claim 1, wherein generating the hotspot model is performed by:
applying weightings to each of multiple input data sets; and
combining the multiple weighted input data sets.

10. The computer-implemented method of claim 9, wherein the weightings are determined by:
obtaining identifiers of existing stations, wherein each of the identifiers is associated with a performance score and a set of features;
identifying relationships between variance in feature values for particular feature types and variance in performance scores; and
establishing a mapping of weightings to feature types based on the identified relationships.

11. The computer-implemented method of claim 10, wherein the performance score associated with at least one of the identifiers of existing stations is:
is based, in part, on an automatic sales performance metric, and
is based, in part, on a user-specified metric.

12. The computer-implemented method of claim 10,
wherein at least two particular data sets of the multiple data sets each have a feature type and each of the at least two particular data sets includes multiple data values, each data value corresponding to a portion of the area;
wherein applying one of the weightings to each of the particular data sets comprises applying, to each data value of that particular data set, a particular weighting mapped to the type of that particular data set in the mapping; and
wherein combining the multiple weighted input data sets comprises combining values from the at least two particular data sets by combining particular weighted data values that correspond to the same portion of the area.

13. The computer-implemented method of claim 1, wherein generating the trade area model is further based on at least one of:
presence of occupied homes;
regional permitting surveillance;
drive-time statistics for sections of roadways; or
any combination thereof.

14. The computer-implemented method of claim 1, further comprising
computing a score for each possible site, of multiple possible sites, by combining:
a first value corresponding to the possible site from the hotspot model, and
a second value corresponding to the possible site from the trade area model; and
selecting, as the multiple proposed installation sites, a number of possible sites dictated by a capacity model that have a score that is above a threshold or that is in a top amount of the computed scores.

15. The computer-implemented method of claim 14, wherein at least one indication of a proposed installation site, of the multiple proposed installation sites, is provided in association with a displayed set of one or more key decision variables that indicate one or more variables that contributed most to the score computed for that proposed installation site.

16. The computer-implemented method of claim 14, wherein the threshold or top amount is based on characteristics of an area comprising one or more of:
residential population density;
industry type;
alternative fuel vehicle density;
existing sales information; or
any combination thereof.

17. A computer-readable storage medium storing instructions that, when executed by a computing system, cause the computing system to perform operations for identifying alternative fuel station sites, the operations comprising:
generating a hotspot model indicating one or more hotspots within the area, wherein each hotspot corresponds to a geographical area within the area that is predicted to have demand for alternative fuels above a threshold level and wherein the hotspot model is determined based on:
a number of vehicles, associated with potential hotspots in the area, that are capable of using alternative fuels;
presence of other alternative fuel stations within a threshold distance of potential hotspots; and
categorized historical sales information, associated with potential hotspots in the area, for categories of alternative fuels;
generating a trade area model indicating one or more trade areas within the area, and wherein the trade area model is determined based on:
predicted drive times, by consumers of alternative fuels, to reach a corresponding potential trade area; and
proximity between potential trade areas and residences with occupants below a threshold age; and
generating, based on the hotspot model and the trade area model, indications of multiple proposed installation sites for alternative fuel stations.

18. The computer-readable storage medium of claim 17, wherein the operations further comprise indicating an order among the multiple proposed installation sites, wherein the order is based on one or more of:
an amount of trade volume in a corresponding trade area;
residential proximity values;
site or area demographics;
area draw variables; or
any combination thereof.

19. A system for identifying alternative fuel station sites within an area, the system comprising:
one or more processors; and
a memory storing instructions that, when executed by the one or more processors, cause the system to perform operations comprising:
obtaining identifiers of existing fuel stations, wherein each of the identifiers is associated with a performance score and a set of features;
identifying relationships between variance in feature values for particular feature types and variance in performance scores;
establishing a mapping of weightings for feature types based on the identified relationships;
obtaining at least two data sets that each have a feature type, wherein each of the at least two particular data sets includes multiple data values and each data value corresponds to a portion of the area;
applying the mapping of the weightings to the at least two data sets by selecting a weighting to apply to each data set value based on a correspondence, in the mapping, between the applied weighting and the type of that data set,
wherein the at least two data sets include at least a first data set indicating a number of vehicles, associated with portions of the area, that are capable of using alternative fuels, and a second data set indicating presence of other alternative fuel stations within a threshold distance of the portions of the area;
combining values from the at least two data sets into a hotspot model by combining particular weighted data values that correspond to the same portion of the area; and
generating, based on the hotspot model, indications of multiple proposed installation sites for alternative fuel stations.

20. The system of claim 19, wherein the operations further comprise:
generating an area capacity model for the area, wherein the area capacity model indicates estimated capacities, for alternative fuel stations, in each of multiple portions of the area; and
generating a trade area model indicating one or more trade areas within the area, and wherein the trade area model is determined based on proximity between potential trade areas and residences with occupants below a threshold age;
wherein the generating the indications of the multiple proposed installation sites for alternative fuel stations is further based on the area capacity model and the trade area model.
